(19) United States
(12) Patent Application Publication
(10) Pub. No.: US 2017/0238508 A1
(43) Pub. Date: Aug. 24, 2017

(54) Pet Apparel With Fasteners

(71) Applicant: Fernando Rodriguez, Allen, TX (US)

(72) Inventor: Fernando Rodriguez, Allen, TX (US)

(21) Appl. No.: 15/436,837

(22) Filed: Feb. 19, 2017

Related U.S. Application Data
(60) Provisional application No. 62/297,260, filed on Feb. 19, 2016.

(51) Int. Cl. A01K 27/00; A44B 18/00; A01K 13/00; A44B 17/00

(52) U.S. Cl. CPC A01K 27/006; A44B 17/0058; A44B 18/00; A01K 27/001; A01K 27/005; A01K 13/006

(57) ABSTRACT

A collar is provided for securing a pet's apparel. The collar includes fasteners on the underside that are used to connect to fasteners located on the pet's apparel.

### RELATED APPLICATIONS

This application claims the benefit of U.S. Provisional Patent Application No. 62/297,260 filed Feb. 19, 2016.

All referenced patents and applications are incorporated herein by reference in their entirety. Where a definition or use of a term in an incorporated reference is inconsistent or contrary to that term provided herein, the definition of that term provided herein applies.

### TECHNICAL FIELD

The invention relates generally to pet apparel and more particularly to pet collars.

### BACKGROUND

The background description provided herein is for the purpose of generally presenting the context of the disclosure.

The variety and availability of pet apparel has increased dramatically, but it still can be difficult for an owner to find perfectly fitting apparel for their pet. Apparel that is sized too large or imperfectly designed can slip and sometimes come off the pet.

For the foregoing reason, there is a need for an apparatus that reduces the likelihood of pet apparel slipping or coming off a pet.

### SUMMARY

The present invention provides apparatus that uses fasteners on the underside of a pet collar. The fasteners can provide a more secure fit for a pet's apparel by reducing the likelihood that the apparel will slip or come off.

In a preferred embodiment, a pet collar includes a main strip that has a first fastener and a plurality of second fasteners on the underside of the pet collar.

In some embodiments, the first fastener and each of the second fasteners are the same fastening type, while in others the first fastener is a different fastening type than at least one of the plurality of second fasteners.

In some embodiments, a pet collar includes a main strip of material that has a first fastener, a secondary strip of material that has a plurality of second fasteners, and the secondary strip of material is connected to the main strip of material. In still further embodiments, the secondary strip of material is detachable from the main strip of material.

According to one embodiment, at least one of the plurality of second fasteners is detachable from the main strip of material.

According to another embodiment, a secondary strip for connecting pet apparel to a pet collar includes a fastener on the bottom.

The first fastener and the plurality of second fasteners can be arranged in a configuration, design, and/or pattern. Also, in some embodiments the spacing, size and/or fastening type varies. In some embodiments, the first fastener is a touch fastener, while in others it is an adhesive.

Various objects, features, aspects, and advantages of the present invention will become more apparent from the following detailed description and the accompanying drawings.

### BRIEF DESCRIPTION OF THE DRAWING

Example embodiments will be more clearly understood from the following brief description taken in conjunction with the accompanying figures.

FIG. 1 is a bottom view of a pet collar according to one embodiment.

FIG. 2 is a bottom view of another embodiment of a pet collar.

FIG. 3 is a bottom view of a pet collar according to an embodiment.

FIGS. 4a and 4b are bottom views of an embodiment of a pet collar.

### DETAILED DESCRIPTION

Example embodiments are described with reference to the accompanying figures, like reference numerals being used for like parts.

These figures are not to scale and may not precisely reflect the precise structural or performance characteristics of any given embodiment, and should not be interpreted as defining or limiting the range of values or properties encompassed by example embodiments. For example, the size, positioning and spacing of the fasteners may be reduced or exaggerated for clarity.

When an element is referred to as being “connected” or “coupled” to another element, it can be directly connected or intervening elements may be present. In contrast, when an element is referred to as being “directly connected” or “directly coupled” to another element, there are no intervening elements present. Other words used to describe the relationship between elements or layers should be interpreted in a like fashion (e.g., “between” versus “directly between,” “adjacent” versus “directly adjacent,” “on” versus “directly on”). As used herein the term “and/or” includes any and all combinations of one or more of the associated listed items.

Distinguishing terms such as “main”, “secondary”, “left,” or “right” may be used herein to describe various elements. These terms are only used to distinguish one element from another, and should not be interpreted as limiting the element. Thus, a main element could be termed a secondary element without departing from the teachings of the example embodiments.

Placing fasteners on the underside of a collar can provide a more secure fit for apparel that is worn by a pet by reducing the likelihood that it will slip or come off. The underside is the side that is generally not visible when the collar is attached to the pet. The topside of the collar may have name tags, embroidering, fasteners and/or other decorative elements that would generally be visible when the collar is attached.

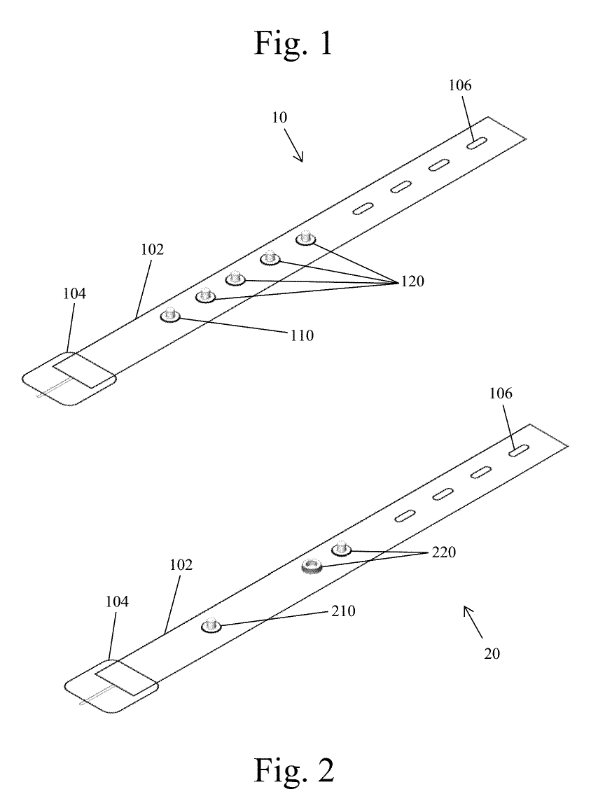

FIG. 1

Referring now to the drawing, FIG. 1 shows an illustrative embodiment of the underside of an improved pet collar. Pet collar 10 comprises a main strip 102 of material that attaches around a pet's neck by coupling a first connector 104 that is located on the left end with a second connector 106 that is located on the right end.

The main strip 102 is similar to that known in the art. It can comprise any material or combination of materials that are suitable to be used as a collar, for example, leather, nylon, cotton, hemp, plastics, polypropylene, metals, elastic materials or other materials.

The first connector 104 and the second connector 106 are also known in the art and can comprise any suitable connecting mechanism, for example, a buckle and holes, snaps, side release buckles, or other connecting mechanism. It should be apparent to those skilled in the art that the suitability of materials, connectors and fasteners may depend on a number of factors, including the price point of the collar and/or the animal's size, weight, breed and disposition.

In this illustrative embodiment, a first fastener 110 and a plurality of second fasteners 120 are fixedly connected on the underside of the main strip 102, and therefore may reduce the obscuring of some decorative elements or identification that would be placed on the topside of pet collar 10. The first fastener 110 and the plurality of second fasteners 120, in this embodiment, are male snap fasteners that can be used to connect any apparel that has compatible fasteners, female snap fasteners. For example, a pet jacket with a removable hood is well-known and has female snap fasteners surrounding the outside of the jacket's collar. With the hood removed, the jacket could fasten to the underside of the pet collar 10, and the hood could be connected to female snap fasteners (not shown) that are located on the topside of the pet collar 10.

The first fastener 110 and the plurality of second fasteners 120 are arranged in a line along the main strip 102. However, the first fastener 110 and the plurality of second fasteners 120 can be arranged in any configuration, design and/or pattern. For example, a majority or all of the fasteners can be grouped on one side or the spacing can be varied so that the space between fasteners gets larger when going outwards from the center. In pet collar 10, there is one first fastener 110 and four second fasteners 120, but it is contemplated that the number of fasteners may be varied.

Any suitable fastener can be used, for example, male and female snap fasteners, hooks and loops, buttons and buttonholes, hooks and eyes or other fasteners.

FIG. 2

Pet collar 20, an illustrative embodiment, is depicted in FIG. 2. In this embodiment, the first fastener 210 is a male snap fastener and the plurality of second fasteners 220 includes both a male and a female snap fastener. These fasteners are arranged in an alternating pattern, but other patterns are contemplated. Additionally, different fastener types can be used, for example, the plurality of second fasteners 220 can comprise male snap fasteners and Velcro.

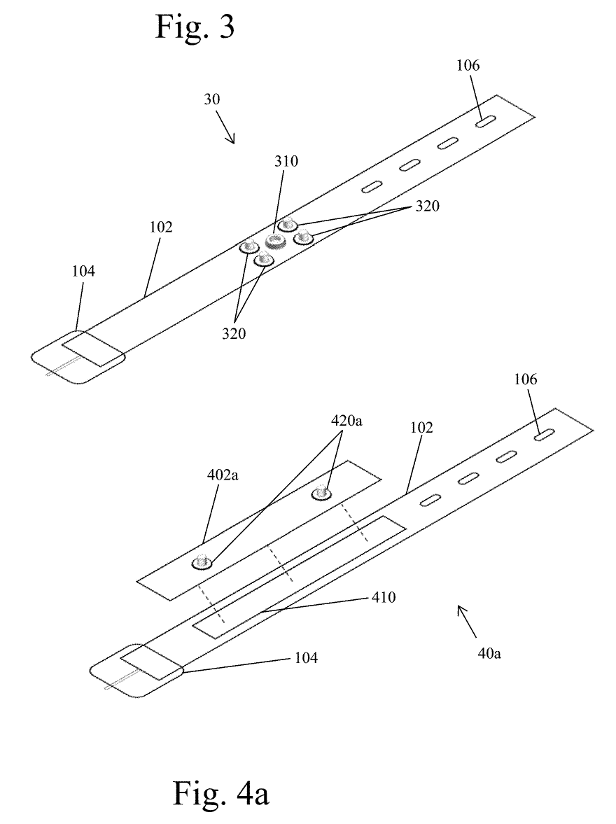

FIG. 3

As shown in the illustrative embodiment of FIG. 3, the plurality of second fasteners 320 are arranged in a pattern around the first fastener 310 on pet collar 30. Arranging the first fastener 310 and the plurality of second fasteners 320 in a configuration, design, and/or pattern may restrict the fastening of apparel, such as t-shirts, to those that have a similar arrangement. Any configuration, design and/or pattern is contemplated and may include all or only a portion of the fasteners. For example, a portion or all of the fasteners can be formed into a design, for example, a star or an apparel's brand.

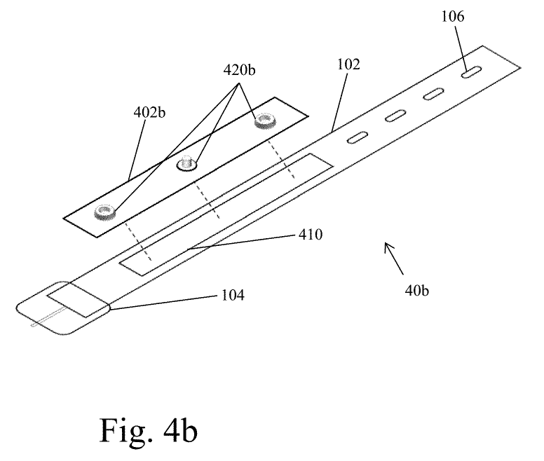

FIGS. 4a and 4b

In the illustrative embodiment of FIG. 4a, the first fastener 410 is a touch fastener that couples to a compatible touch fastener (not shown) that is located on the bottom of the secondary strip 402a. This allows the secondary strip 402a and the plurality of second fasteners 420a to be detachable from the main strip 102. The first fastener 410 can comprise any type, and it may also be used with other fasteners to aid in connecting the secondary strip 402a.

In the illustrative embodiment of FIG. 4b, the plurality of second fasteners 420a (not shown) are detached and replaced with a secondary strip 402b that has a different arrangement of second fasteners 420b. In pet collars (40a, 40b), all of the second fasteners (420a, 420b) are detachable, but it is contemplated that some may not be detachable from the main strip 102.

The secondary strip (402a, 402b) can comprise the same materials as the main strip 102 or a different material. For example, the main strip 102 can be made of leather and the secondary strip (402a, 402b) can have a central portion made from an elastic material and the outer ends made of leather. Alternatively, the secondary strip (402a, 402b) can have the outer ends comprised of an elastic material and the central portion comprised of leather and a metal. Constructing a portion of the strip with an elastic material can allow for variations in size and spacing.

In FIGS. 4a and 4b, the two secondary strips (402a, 402b) have a different configuration of fasteners. It is contemplated that they could have the same configuration and/or may have a different size or shape.

It is also contemplated, that an optional strip can have fasteners that are compatible with at least some of the fasteners that are connected to the main strip 102 such that the strip can cover up at least a portion of the fasteners. Covering up the fasteners that are located underneath the pet collar prevents them from touching the pet's neck when not in use.

Various modifications may be made to the described embodiments without departing from the spirit and scope of the invention. Features shown and described in each of the implementations may be used independently or in combination with one another.

The specification and the described embodiments are merely exemplary of the invention, with the true scope of the invention being defined by the following claims.

1. A pet collar for providing a more secure fit for pet apparel, comprising:
a main strip;
a first connector connected to the left end of the main strip;
a second connector connected to the right end of the main strip;
a first fastener fixedly connected to the underside of the main strip; and
a plurality of second fasteners connected to the underside of the main strip.

2. The pet collar of claim 1, wherein the first fastener is the same fastening type as the plurality of second fasteners.

3. The pet collar of claim 1, wherein the first fastener is a different fastening type than at least one of the plurality of second fasteners.

4. The pet collar of claim 3, wherein the plurality of second fasteners are snap fasteners.

5. The pet collar of claim 1, wherein the spacing between the first fastener and each of the plurality of second fasteners is approximately equal.

6. The pet collar of claim 1, wherein the spacing varies between the first fastener and each of the plurality of second fasteners.

7. The pet collar of claim 1, wherein the arrangement of the plurality of the second fasteners comprises a pattern.

8. The pet collar of claim 7, wherein the pattern includes the first fastener.

9. The pet collar of claim 1, further comprising:
a secondary strip connected to the main strip.

10. The pet collar of claim 9, wherein the secondary strip is comprised of a material that is different than a material of the main strip.

11. The pet collar of claim 9, wherein the secondary strip is detachable from the main strip.

12. The pet collar of claim 9, wherein at least one of the plurality of second fasteners is detachable from the main strip.

13. The pet collar of claim 9, wherein the first fastener is a touch fastener.

14. The pet collar of claim 9, wherein the secondary strip further comprises:
a top;
a bottom; and
a third fastener connected to the bottom.
